(19) United States
(12) Patent Application Publication
(10) Pub. No.: US 2026/0008018 A1
(43) Pub. Date: Jan. 8, 2026

(54) POTTING AGENT FOR SEPARATION MEMBRANE MODULE AND SEPARATION MEMBRANE MODULE

(71) Applicant: UNITIKA LTD, Osaka (JP)

(72) Inventors: Tatsunori MASAKI, Kyoto (JP); Kuniko INOUE, Kyoto (JP); Keisuke MAEDA, Kyoto (JP)

(21) Appl. No.: 18/692,852

(22) PCT Filed: Sep. 22, 2022
(86) PCT No.: PCT/JP2022/035514

§ 371 Date: Sep. 22, 2025

(30) Foreign Application Priority Data
Sep. 29, 2021 (JP) 2021-159224

(51) Int. Cl. B01D 71/56; B01D 61/00; B01D 69/02

(52) U.S. Cl. CPC B01D 71/56; B01D 61/00; B01D 69/02; B01D 2313/025

(57) ABSTRACT

The present invention mainly addresses the problem of providing: a potting agent for manufacturing a separation membrane module having excellent resistance to a highly soluble organic solvent; and a separation membrane module obtained by using the potting agent. A potting agent for a separation membrane module according to the present invention contains an epoxy compound and an imidazole compound.

### TECHNICAL FIELD

The present invention relates to a potting agent for a separation membrane module and a separation membrane module.

### BACKGROUND ART

Conventionally, separation membranes have been put to practical use in various fields such as removal of bacteria and viruses in the water purification field, separation or concentration of substances weak to heat such as proteins and enzymes in the industrial field, artificial dialysis in the medical field, removal of viruses and proteins during production of pharmaceuticals and medical water, production of ultrapure water, recovery of electrodeposition paint, sewage treatment in a yarn making and pulp mill, treatment of oil-impregnated wastewater, treatment of building wastewater, clarification of fruit juice, production of raw sake, concentration and desalination of cheese whey, production of concentrated milk, concentration of albumen, use in a bioreactor, removal of fine particles in gas, and water treatment in a nuclear power plant. In particular, in recent years, an approach to a sustainable society has been regarded as very important, and effective use of waste liquid discharged from a manufacturing process and an energy-saving separation process have been required, and membrane separation technology has attracted more attention. Under such circumstances, many separation membrane modules have already been commercialized for water systems. However, at present, there are few separation membrane modules that can be used for organic solvent waste liquid. Various types of organic solvents are used in various fields, and among them, organic solvents having very high solubility are also used, and thus a separation membrane module usable also in such fields is strongly desired.

As a method for manufacturing a hollow fiber membrane module, there is known a method for manufacturing a hollow fiber membrane module, in which when an end portion of a bundle of hollow fiber membranes is sealed and fixed with an adhesive including an epoxy resin and a cationic polymerization curing agent or an anionic polymerization curing agent, the epoxy resin is pre-cured so that a reaction rate reaches 40 to 75% in 2 hours or longer, and then post-cured at a temperature higher than the pre-curing temperature (see, for example, Patent Document 1). According to the manufacturing method, when an end portion of a bundle of hollow fiber membranes is sealed and fixed with an adhesive including an epoxy resin and a cationic polymerization curing agent or an anionic polymerization curing agent, the heat generation temperature during curing of the adhesive can be kept low, and a cured product excellent in solvent resistance, heat resistance, and strength is obtained, whereby a hollow fiber membrane module capable of firmly bonding and fixing a hollow fiber bundle, having excellent solvent resistance, and capable of stably membrane-separating a fluid to be treated over a long period of time is obtained.

### PRIOR ART DOCUMENTS

### Patent Documents

Patent Document 1: Japanese Patent Laid-open Publication No. H8-323157

### SUMMARY OF THE INVENTION

### Problems to be Solved by the Invention

However, as a result of studies of the present inventors, there is a problem in that the potting agent used in the hollow fiber membrane module disclosed in Patent Document 1 has insufficient resistance to a highly soluble organic solvent such as N-methylpyrrolidone (abbreviated as “NMP” hereinafter).

Therefore, a main object of the present invention is to solve the above problems and to provide a potting agent for manufacturing a separation membrane module having excellent resistance to a highly soluble organic solvent; and a separation membrane module obtained by using the potting agent.

### Means for Solving the Problem

The present inventors have conducted intensive studies to achieve the above object, and as a result, have found that a separation membrane module having excellent resistance to a highly soluble organic solvent can be obtained by using a potting agent containing an epoxy compound and an imidazole compound. The present inventors have conducted further studies based on the findings, leading to the completion of the present invention.

That is, the present invention provides inventions of the following aspects.
Item 1. A potting agent for a separation membrane module, containing an epoxy compound and an imidazole compound.
Item 2. The potting agent for a separation membrane module according to Item 1, wherein a content of the imidazole compound is 0.2 to 12 parts by mass per 100 parts by mass of the epoxy compound.
Item 3. The potting agent for a separation membrane module according to Item 1 or 2, wherein the epoxy compound contains one or more selected from the group consisting of a diglycidyl ether type epoxy resin and an epoxy resin having a triazine skeleton.
Item 4. The potting agent for a separation membrane module according to any one of Items 1 to 3, wherein the imidazole compound is 2-ethyl-4-methylimidazole.
Item 5. A separation membrane module potted with the potting agent for a separation membrane module according to any one of Items 1 to 4.
Item 6. The separation membrane module according to Item 5, wherein the separation membrane is a membrane containing polyamide.
Item 7. The separation membrane module according to Item 5 or 6, wherein the separation membrane module is used for causing a liquid to be treated containing an organic solvent to pass through the separation membrane module to separate a substance to be separated in the liquid to be treated.
Item 8. The separation membrane module according to Item 7, wherein the organic solvent is an aprotic polar solvent.
Item 9. The separation membrane module according to any one of Items 5 to 8, wherein both of a permeation amount retention rate and a rejection rate retention rate after a treatment in which the separation membrane module is filled with N-methylpyrrolidone and left to stand still for 672 hours are 80% or more.
Item 10. A separation method including causing a liquid to be treated containing an organic solvent to pass through the separation membrane module according to any one of Items 5 to 9 to separate a substance to be separated in the liquid to be treated.
Item 11. Use of a composition containing an epoxy compound and an imidazole compound as a potting agent in manufacturing of a separation membrane module.
Item 12. A method for manufacturing a separation membrane module including a case and a separation membrane housed in the case, the method including:
a potting step of housing the separation membrane in the case and fixing the housed separation membrane in the case with the potting agent for a separation membrane module according to any one of Items 1 to 4.

### Advantages of the Invention

When the potting agent for a separation membrane module of the present invention is used, since the potting agent contains an epoxy compound and an imidazole compound, a separation membrane module having excellent resistance to a highly soluble organic solvent can be obtained.

### BRIEF DESCRIPTION OF THE DRAWINGS

FIG. 1 is a plan view of a separation membrane module according to an embodiment.

FIG. 2 is a partial cross-sectional view of a case of the separation membrane module according to the embodiment.

FIG. 3 is an end view of the separation membrane module according to the embodiment.

FIG. 4 is a partial cross-sectional view of the separation membrane module according to the embodiment.

FIG. 5 is a schematic view of a separation treatment line.

FIG. 6 is a schematic view of a potting device according to an embodiment.

### EMBODIMENTS OF THE INVENTION

### [Potting Agent for Separation Membrane Module]

A potting agent for a separation membrane module of the present invention contains an epoxy compound and an imidazole compound. Hereinafter, the potting agent for a separation membrane module (also simply referred to as “potting agent” hereinafter) of the present invention will be described in detail.

### 1. Epoxy Compound

The potting agent of the present invention contains an epoxy compound.

The epoxy compound in the present invention is a compound having at least two epoxy groups in the molecule. Examples of the epoxy compound include a diglycidyl ether type epoxy compound, a polyfunctional glycidyl ester type epoxy compound (a glycidyl ester type epoxy compound having three or more glycidyl groups), a diglycidyl ester type epoxy compound, a polyfunctional glycidyl amine type epoxy compound (a glycidyl amine type epoxy compound having three or more glycidyl groups), an alicyclic epoxy compound, an aliphatic linear epoxy compound, an epoxy resin having a triazine skeleton, and a novolac type epoxy resin.

Examples of the diglycidyl ether type epoxy compound include bisphenol A diglycidyl ether, bisphenol F diglycidyl ether, bisphenol S diglycidyl ether, and resorcinol diglycidyl ether. Examples of the polyfunctional glycidyl ester type epoxy compound include triglycidyl ether triphenylmethane and tetraglycidyl ether tetraphenylethane. Examples of the diglycidyl ester type epoxy compound include phthalic acid diglycidyl ester and dimer acid diglycidyl ester. Examples of the polyfunctional glycidyl amine type epoxy compound include N,N,N,N-tetraglycidyldiaminodiphenylmethane and tetraglycidylmetaxylenediamine. Examples of the alicyclic epoxy compound include 3,4-epoxycyclohexylmethylcarboxylate. Examples of the aliphatic linear epoxy compound include epoxidized soybean oil. Examples of the epoxy resin having a triazine skeleton include triglycidyl isocyanurate and tris(4,5-epoxypentyl) isocyanurate. Examples of the novolac type epoxy resin include a phenol novolac type epoxy resin and a cresol novolac type epoxy resin.

The epoxy compound may be used singly or in combination of two or more kinds thereof. Among them, from the viewpoint of more excellent resistance to a highly soluble organic solvent, one or more selected from the group consisting of a diglycidyl ether type epoxy resin and an epoxy resin having a triazine skeleton are preferable, and a diglycidyl ether type epoxy resin or an epoxy resin having a triazine skeleton is more preferable.

The epoxy equivalent of the epoxy compound is not particularly limited, and is, for example, 100 to 300 g/eq. When the separation membrane is a hollow fiber membrane, from the viewpoint of more uniformly sealing a gap between the hollow fiber membrane bundle and the inner peripheral surface of the module case while further suppressing the blockage of the hollow portion (through-hole) of the hollow fiber membrane by the potting agent, the epoxy equivalent of the epoxy compound is preferably 150 to 300 g/eq, more preferably 180 to 250 g/eq, and still more preferably 230 to 270 g/eq. In the present invention, the epoxy equivalent of the epoxy compound is measured according to a potentiometric titration method defined in JIS K 7236:2001 (Determination of epoxy equivalent in epoxy resins). Specifically, a precisely weighed sample is dissolved in chloroform, acetic acid and a tetraethylammonium bromide-acetic acid solution are added, and then potentiometric titration is performed with 0.1 mol/L perchloric acid-acetic acid standard solution.

The content of the epoxy compound in the potting agent of the present invention is, for example, 90 to 99.5 mass %, and is preferably 92 to 99.5 mass % and more preferably 92 to 97 mass % from the viewpoint of more excellent resistance to a highly soluble organic solvent.

### 2. Imidazole Compound

The potting agent of the present invention contains an imidazole compound.

In the present invention, the imidazole compound is a compound having an imidazole skeleton in the molecule. Examples of the imidazole compound include imidazole having one or more alkyl groups having 1 to 20 carbon atoms such as 2-methylimidazole, 2-ethylimidazole, 2-ethyl-4-methylimidazole, 2-undecylimidazole, and 2-heptadecylimidazole, imidazole having one or more aryl groups such as 2-phenylimidazole, imidazole having one or more alkyl groups having 1 to 20 carbon atoms and one or more aryl groups such as 1-benzyl-2-methylimidazole, and imidazole having one or more alkyl groups having 1 to 20 carbon atoms and one or more cyano groups such as 1-cyanoethyl-2-methylimidazole and 1-cyanoethyl-2-ethyl-4-methylimidazole.

The imidazole compound may be used singly or in combination of two or more kinds thereof. Among them, from the viewpoint of more excellent resistance to a highly soluble organic solvent, at least one selected from the group consisting of imidazole having one or more alkyl groups having 1 to 20 carbon atoms, imidazole having one or more aryl groups, imidazole having one or more alkyl groups having 1 to 20 carbon atoms and one or more aryl groups, and imidazole having one or more alkyl groups having 1 to 20 carbon atoms and one or more cyano groups is preferable, imidazole having one or more alkyl groups having 1 to 20 carbon atoms is more preferable, imidazole having one or more alkyl groups having 1 to 12 carbon atoms is still more preferable, imidazole having one or more alkyl groups having 1 to 6 carbon atoms is particularly preferable, imidazole having one or more alkyl groups having 1 to 4 carbon atoms is further preferable, and 2-ethyl-4-methylimidazole is still further preferable.

The content of the imidazole compound in the potting agent of the present invention is, for example, 0.5 to 10 mass %, and is preferably 1.5 to 7 mass %, more preferably 2.5 to 5 mass %, and still more preferably 3 to 4 mass % from the viewpoint of more excellent resistance to a highly soluble organic solvent.

### 3. Mass Ratio of Epoxy Compound and Imidazole Compound

In the potting agent of the present invention, as the mass ratio of the epoxy compound and the imidazole compound, for example, the content of the imidazole compound is 0.2 to 12 parts by mass per 100 parts by mass of the epoxy compound. From the viewpoint of more excellent resistance to a highly soluble organic solvent, the content of the imidazole compound is preferably 1 to 10 parts by mass, more preferably 1.5 to 10 parts by mass, still more preferably 1.5 to 8 parts by mass, particularly preferably 1.5 to 5 parts by mass, further preferably 1.5 to 4 parts by mass, still further preferably 2.1 to 4 parts by mass, and still further preferably 3 to 4 parts by mass, per 100 parts by mass of the epoxy compound.

### 4. Total Content of Epoxy Compound and Imidazole Compound

In the potting agent of the present invention, the total content of the epoxy compound and the imidazole compound is, for example, 25 to 100 mass %. The total content is preferably 75 to 100 mass %, more preferably 90 to 100 mass %, still more preferably 95 to 100 mass %, and particularly preferably 100 mass %, from the viewpoint of more excellent resistance to a highly soluble organic solvent.

### 5. Other Components

The potting agent of the present invention can contain components other than the epoxy compound and the imidazole compound as long as the effect of the present invention is exhibited, but it is preferable not to contain other components from the viewpoint of more excellent resistance to a highly soluble organic solvent. Examples of the other components include a curable resin other than the epoxy compound, a plasticizer, a curing agent, a viscosity modifier, an impact resistance modifier, a filler, a pigment, and an antifoaming agent. The content of the other components in the potting agent of the present invention is, for example, 0.1 to 75 mass %, and is preferably 0.1 to 25 mass %, more preferably 0.1 to 10 mass %, and still more preferably 0.1 to 5 mass %.

Among the other components, examples of the curing agent include polyaddition type curing agents such as a polyamine compound and an acid anhydride. On the other hand, it is preferable that the potting agent of the present invention does not contain a polyaddition type curing agent as much as possible from the viewpoint of more excellent resistance to a highly soluble organic solvent. In this case, the content of the polyaddition type curing agent is preferably 10 parts by mass or less, more preferably 5 parts by mass or less, still more preferably 1 part by mass or less, particularly preferably 0.5 parts by mass or less, and further preferably 0 parts by mass (that is, the polyaddition type curing agent is not contained), per 100 parts by mass of the epoxy compound.

### 6. Viscosity Before Curing of Potting Agent

The viscosity of the potting agent of the present invention is not particularly limited, and for example, a viscosity before curing measured using a B-type viscometer under the condition of 40° C. is 5 to 1000 P (poise). When the separation membrane is a hollow fiber membrane, from the viewpoint of more uniformly sealing a gap between the hollow fiber membrane bundle and the inner peripheral surface of the module case while further suppressing the blockage of the hollow portion (through-hole) of the hollow fiber membrane by the potting agent, the viscosity is preferably 10 to 800 P, more preferably 300 to 800 P, and still more preferably 400 to 700 P. In the present invention, the viscosity before curing of the potting agent is measured according to a viscosity measurement method using a co-axial double cylindrical rotary viscometer specified in 8 of JIS Z 8803:2011 after raw materials such as an epoxy compound and an imidazole compound constituting the potting agent are mixed and degassed for 30 seconds using a vacuum pump. More specifically, an outer cylinder having an inner diameter of 12 mm and a depth of 47 mm, and a rotor (high viscosity type) having an outer diameter of 7.6 mm are used, 2.5 ml of the potting agent before being cured is placed in the outer cylinder, a spindle is inserted therein, the temperature is kept constant in a water bath set at 40° C., and then the viscosity is measured using a B-type viscometer (inner cylinder constant speed type) by appropriately adjusting the number of revolutions to the number of revolutions at which the measurement is possible. The number of revolutions is, for example, 30 to 60 rpm when the viscosity of the potting agent is 0 to 36 P and 0.6 to 1.5 rpm when the viscosity of the potting agent is 360 to 1800 P.

### [Separation Membrane Module]

A separation membrane module of the present invention is potted with the above-described potting agent for a separation membrane module of the present invention. In the present invention, the phrase “potted with the potting agent for a separation membrane module” refers to a state where a separation membrane is liquid-tightly or airtightly fixed to an inner wall surface of a case housing the separation membrane by a cured product of the potting agent for a separation membrane module. Hereinafter, an embodiment of the separation membrane module according to the present invention will be described. However, the separation membrane module according to the present invention is not limited to the following embodiment, and a known embodiment can be adopted except that the separation membrane module includes a cured product of the potting agent of the present invention.

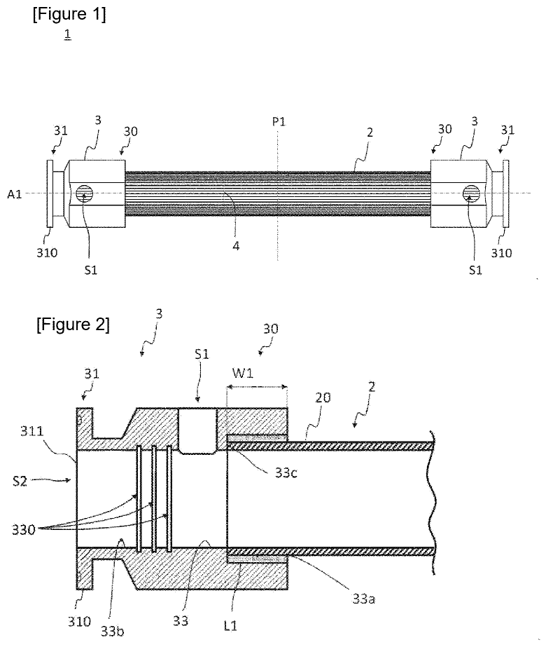

FIG. 1 is a plan view of a separation membrane module 1 of the present embodiment. The separation membrane module 1 has a substantially cylindrical exterior shape as a whole and is configured to be symmetric with respect to a plane P1 (see FIG. 1) passing through the center of the separation membrane module 1.

The separation membrane module 1 includes a casing 2, a cap 3, and a separation membrane 4. The casing 2, the cap 3, and the separation membrane 4 are each made of a material having resistance to an organic solvent. The casing 2 and the cap 3 are bonded and fixed to each other, thereby constituting a case for housing the separation membrane 4 therein (simply referred to as “case” in the present specification). The separation membrane 4 of the present embodiment is a hollow fiber membrane bundle in which a large number of hollow fiber membranes are bundled. Hereinafter, the hollow fiber membrane bundle is also given the same reference numeral as the separation membrane 4.

The casing 2 of the present embodiment has a cylindrical exterior shape that is open at both ends, and has a central axis A1. Hereinafter, a direction in which the central axis A1 extends (the left-right direction in FIG. 1) is referred to as the axial direction. The length in the axial direction, diameter, and thickness of the casing 2 can be appropriately selected according to the type of the separation membrane 4 housed in the case, the pressure of a fluid, and the like.

Examples of the material constituting the casing 2 include resin materials such as polyamide, polyethylene, polypropylene, polyetheretherketone, polyphenyl sulfone, polyphenylene sulfide, polytetrafluoroethylene, and ethylene chlorotrifluoroethylene, and metals such as stainless steel and aluminum. These materials may be used singly or in combination of two or more kinds thereof. The resin materials may be either uncrosslinked or crosslinked, and uncrosslinked resin materials are preferable from the viewpoint of manufacturing cost of the separation membrane module. Additives such as a filler and a processing aid may be added to the resin material described above. However, since elution into an organic solvent passing through the separation membrane module is concerned, it is preferable to avoid the use of an organic additive as much as possible, and it is more preferable that the resin material does not contain an organic additive.

The cap 3 is a portion to be attached to both end portions of the casing 2 to enable installation of the separation membrane module 1 in a solution treatment line. Since the two caps 3 of the separation membrane module 1 of the present embodiment have the same configuration, the following description on the caps will be made with reference to only one of them. The cap 3 of the present embodiment has a substantially cylindrical exterior shape, and is fixed to the casing 2 with its central axis aligned with the central axis A1 of the casing 2. The cap 3 has a first end portion 30 and a second end portion 31. The first end portion 30 is a portion to be fixed to the end portion of the casing 2. The second end portion 31 is an end portion that is on a side opposite to the first end portion 30 across a passage S2 described below. The second end portion 31 of the present embodiment has a flange portion 310 formed in a flange shape so as to be connectable as a ferrule to piping of a separation treatment line.

FIG. 2 is a cross-sectional view of a region near an end portion of the case. As illustrated in FIG. 2, the cap 3 has an inner wall surface 33. The inner wall surface 33 defines a passage S1 extending in the radial direction and the passage S2 extending in the axial direction. As illustrated in FIG. 1, in a state where the hollow fiber membrane bundle 4 is housed in the case, the hollow fiber membrane bundle 4 can be directly visually recognized from the passage S1. As illustrated in FIG. 2, an end opening of the passage S2 is defined by a peripheral edge 311 of an end face of the second end portion 31.

The passages S1 and S2 are both passages for providing communication between the internal space of the casing 2 (or the case) and the external space, and function as a primary side port and a secondary side port of the separation membrane module 1. The primary side port is a port into which a fluid before being subjected to separation flows, and the secondary side port is a port from which the fluid after being subjected to separation flows out. According to the mode of separation, the separation membrane module 1 may have one or more secondary side ports, and the passages S1 and S2 both can be used as either the primary side port or the secondary side port. In the present embodiment, the passage S2 on one side is used as the primary side port. That is, in the present embodiment, the passage S2 on the other side and the two passages S1 are used as the secondary side ports. In normal use of the separation membrane module 1, one of the two passages S1 may be closed without being used as the secondary side port. In the present embodiment, the fluid that has flowed from the passage S2 serving as the primary side port and then has passed through pores of the hollow fiber membrane bundle 4 described below flows out from the passages S1 serving as the secondary side ports. The remaining fluid passes through hollow portions (through-holes) of the hollow fiber membrane bundle 4 and then flows out from the other passage S2 serving as the secondary side port.

The inner wall surface 33 of the present embodiment has an inner peripheral surface 33a and an inner peripheral surface 33b having a smaller diameter than the inner peripheral surface 33a. The inner peripheral surface 33a is a peripheral surface located on the inner side of the first end portion 30. The inner diameter of the cap 3 in the first end portion 30 is the same as the outer diameter of the casing 2 or slightly larger than the outer diameter of the casing 2. As a result, the inner peripheral surface 33a receives the end portion of the casing 2 and covers an outer peripheral surface 20 of the casing 2 from the outer side in the radial direction. The inner diameter of a portion of the cap 3 excluding the first end portion 30 is approximately the same as the inner diameter of the casing 2, and when the cap 3 receives the end portion of the casing 2, the inner wall surface of the casing 2 is configured to be approximately flush with the inner peripheral surface 33b. A surface 33c with which the inner peripheral surface 33a and the inner peripheral surface 33b are continuous is a surface orthogonal to the axial direction, and the received end face of the casing 2 abuts against the surface 33c.

The cap 3 of the present embodiment further has three grooves 330 formed on the inner peripheral surface 33b. The grooves 330 are formed on the inner peripheral surface 33b at a position closer to the center in the axial direction than the end face of the second end portion 31 is and closer to the end in the axial direction than the passage S1 is. The grooves 330 are formed for making the surface of the inner peripheral surface 33b substantially uneven to increase the surface area of the inner peripheral surface 33b, thereby reinforcing adhesion between a cured product 5 of a potting agent described below and the inner peripheral surface 33b. Such a treatment of increasing the surface area as described above is not limited to providing the grooves 330, and may be a surface roughening treatment such as roughing the inner peripheral surface 33b through etching, sand-blasting, or cutting.

Examples of the material constituting the cap 3 include resin materials such as polyamide, polyethylene, polypropylene, polyetheretherketone, polyphenyl sulfone, polyphenylene sulfide, polytetrafluoroethylene, and ethylene chlorotrifluoroethylene, and metals such as stainless steel and aluminum. These materials may be used singly or in combination of two or more kinds thereof. The resin materials may be either uncrosslinked or crosslinked, and uncrosslinked resin materials are preferable from the viewpoint of manufacturing cost of the separation membrane module. Additives such as a filler and a processing aid may be added to the resin material described above. However, since elution into an organic solvent passing through the separation membrane module is concerned, it is preferable to avoid the use of an organic additive as much as possible, and it is more preferable that the resin material does not contain an organic additive.

The cap 3 of the present embodiment is made of polyamide 6 and is preferably made of the same material as that of the casing 2. However, the material constituting the cap 3 may be different from the material constituting the casing 2 as long as the material has resistance to an organic solvent. The wall thickness of the cap 3 may be different from or the same as the wall thickness of the casing 2.

As described above, in the separation membrane module 1 of the present embodiment, the casing 2 and the cap 3 are bonded and fixed to each other to constitute a case for housing the separation membrane 4. In the separation membrane module 1 of the present invention, the casing 2 and the cap 3 may be integrated to constitute a case, and the present invention is not limited to bonding and fixing. For example, the casing 2 and the cap 3 may be molded and processed as a case in which the casing 2 and the cap 3 are integrated in advance, and means other than bonding and fixing, for example, connection by screw fitting, joining by welding, or the like may be used as the integration means.

In the case of the present embodiment, the outer peripheral surface 20 of the casing 2 and the inner peripheral surface 33a of the first end portion 30 face each other. A layer L1 formed of an adhesive is disposed between the outer peripheral surface 20 and the inner peripheral surface 33a. The layer L1 is a layer located closer to the end in the axial direction, and in the present embodiment, the layer L1 is formed in an annular shape extending from the edge of the casing 2 with a predetermined width W1 in the axial direction. However, for the sake of convenience in illustration, the thickness of the layer L1 in the radial direction is exaggerated in the drawings, and does not necessarily represent an actual scale.

The adhesive bonds and fixes the casing 2 and the cap 3 to each other, and seals a gap between the casing 2 and the cap 3. The adhesive preferably has resistance to an organic solvent, and can be suitably used as a seal against a fluid containing an organic solvent.

The material constituting the adhesive is not particularly limited, and examples thereof include materials selected from the group consisting of a polyamide-based adhesive, a polyethylene-based adhesive, a polypropylene-based adhesive, a phenol resin-based adhesive, a polyimide-based adhesive, a polyurea resin-based adhesive, an epoxy resin-based adhesive, a silicone resin-based adhesive, a modified silicone-based adhesive, an acryl-modified silicone-based adhesive, a urethane-based adhesive, a vinyl acetate-based adhesive, epoxy-modified silicone adhesive, a styrene butanediene rubber-based adhesive, and the like, preferably include materials selected from the group consisting of a polyamide-based adhesive, a polyethylene-based adhesive, and an epoxy resin-based adhesive. These materials may be used singly or in combination of two or more kinds thereof. In particular, from the viewpoint of more excellent resistance to a highly soluble organic solvent, an epoxy resin-based adhesive is preferable, and it is more preferable to use the potting agent of the present invention as the adhesive. In the present embodiment, the potting agent of the present invention is also used as the adhesive.

The hollow fiber membrane bundle 4 formed by bundling a large number of hollow fiber membranes is housed in the case of the present embodiment. Each hollow fiber membrane constituting the hollow fiber membrane bundle 4 has a hollow structure with a through-hole passing therethrough in the longitudinal direction and also has numerous pores inside. The diameter of the pore may be appropriately adjusted according to the diameter of the molecule intended to be separated from a fluid, and the hollow fiber membrane may be any of a microfiltration membrane, an ultrafiltration membrane, and a nanofiltration membrane. In the present embodiment, a fluid that has flowed into the separation membrane module 1 through the primary side port (one of the passages S2) flows into the through-holes (hollow portions) extending in the longitudinal direction in the respective hollow fiber membranes constituting the hollow fiber membrane bundle 4. Of molecules contained in the fluid that has flowed into the hollow portions, those small enough to pass through the pores pass through the hollow fiber membranes by flowing out from the hollow portions through the pores and are then discharged from the passages S1 serving as the secondary side ports to the outside of the separation membrane module 1. Molecules that have not passed through the pores of the hollow fiber membranes are discharged to the outside of the separation membrane module 1 from the passage S2 serving as the secondary side port.

The material constituting the separation membrane 4 is not particularly limited, and examples thereof include polyethylene, polypropylene, polytetrafluoroethylene, polyvinylidene fluoride, polyethersulfone, polyarylate, polyetheretherketone, polyphenylene sulfide, polyvinyl chloride, polyester, cellulose acetate, cellulose, polyamide, polyamideimide, polyimide, and polyetherimide. These may be used singly or in combination of two or more kinds thereof. Among the above, polyethylene, polypropylene, polytetrafluoroethylene, polyetheretherketone, polyphenylene sulfide, polyester, cellulose, polyamide, and polyimide are preferable from the viewpoint of having excellent resistance to an organic solvent, and polyamide is particularly preferable from the viewpoint of pressure resistance, separation performance, and heat resistance, which can withstand heat generated by curing of the potting agent, of the separation membrane. One type of polyamide may be used, or a mixture or copolymer of two or more types of polyamide may be used, and examples thereof include polyamide 4, polyamide 46, polyamide 6, polyamide 66, polyamide 610, polyamide 10, polyamide 11, polyamide 12, polyamide 610, polyamide 612, polyamide MXD6, polyamide 4T, polyamide 6T, polyamide 9T, and polyamide 10T.

The shape of the separation membrane 4 is not particularly limited, and examples thereof include a flat membrane and a hollow fiber membrane. Among them, the hollow fiber membrane is suitable in the separation membrane module of the present invention since the hollow fiber membrane has a large filtration area per unit volume of the separation membrane module and can efficiently perform a filtration treatment.

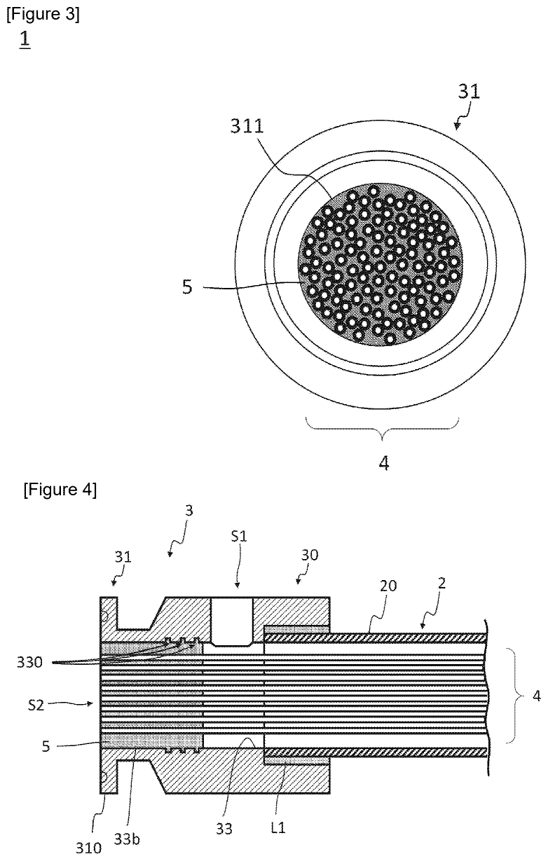

FIG. 3 is an end view of the separation membrane module 1, and FIG. 4 is a partial cross-sectional view of the separation membrane module 1. The hollow fiber membranes constituting the hollow fiber membrane bundle 4 of the present embodiment are aligned such that their both end faces are aligned with the both end faces of the case. Therefore, as illustrated in FIG. 3, at the end face of the second end portion 31 of the cap 3, the end face of each hollow fiber membrane can be visually recognized from the opening of the passage S2 (however, FIG. 3 does not show the exact number of hollow fiber membranes actually housed). In the present embodiment, the end portion of each hollow fiber membrane is not closed, and the through-hole extending in the longitudinal direction is in communication with the external space via the opening of the passage S2.

A gap between the end portion of each hollow fiber membrane and the inner peripheral surface 33b of the second end portion 31 is filled with the cured product 5 of the potting agent. The cured product 5 of the potting agent is placed so as to extend from the end face of each hollow fiber membrane to a position closer to the end in the axial direction than the passage S1 is, thereby binding each end portion of the respective hollow fiber membranes and also sealing a gap between the hollow fiber membrane bundle 4 and the inner peripheral surface 33b to separate a fluid before being subjected to separation and a fluid after being subjected to separation. On the other hand, the cured product 5 of the potting agent does not close the end portion of each hollow fiber membranes.

Since the separation membrane module of the present invention is potted with the above-described potting agent of the present invention, resistance to the highly soluble organic solvent is excellent. As the preferred resistance of the separation membrane module of the present invention, both of a permeation amount retention rate and a rejection rate retention rate after a treatment in which the separation membrane module is filled with N-methylpyrrolidone and left to stand still for 672 hours are preferably 80% or more. The permeation amount retention rate and the rejection rate retention rate refer to the ratio of the permeation amount and the rejection rate of the separation membrane module after a lapse of 672 hours in a state where the separation membrane module is filled with N-methylpyrrolidone to the permeation amount and the rejection rate of the separation membrane module before the separation membrane module is filled with N-methylpyrrolidone. The permeation amount retention rate is preferably 80% or more, more preferably 80% or more and 115% or less, still more preferably 80% or more and 110% or less, particularly preferably 90% or more and 110% or less, and further preferably 95% or more and 105% or less. When the permeation amount retention rate is 115% or less, the expansion of pores of the separation membrane caused by the highly soluble organic solvent in the liquid to be treated is further suppressed, and a separation membrane module having more excellent resistance to the highly soluble organic solvent can be obtained. On the other hand, the rejection rate retention rate is preferably 80% or more, more preferably 90% or more, and still more preferably 95% or more. When the rejection rate retention rate is 80% or more, swelling or erosion of the separation membrane or the cured product of the potting agent caused by the highly soluble organic solvent in the liquid to be treated is further suppressed. This makes it easier to suppress a decrease in rejection rate due to the leakage of the liquid to be treated from expansion of pores or cracks in the cured product of the potting agent by the highly soluble organic solvent in the liquid to be treated.

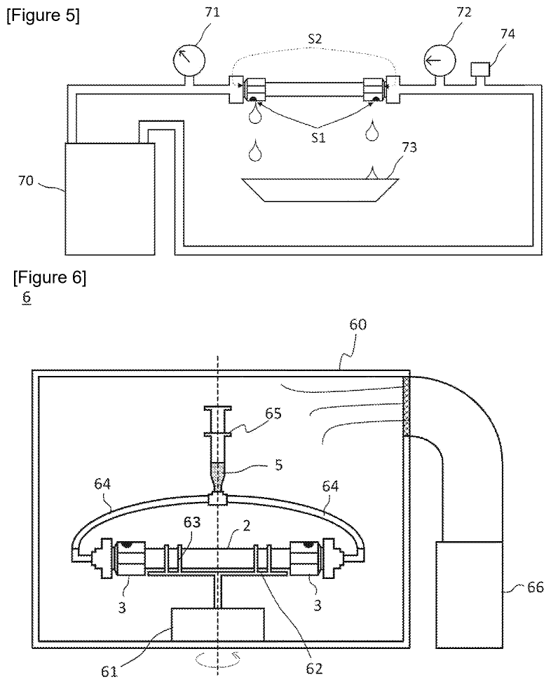

Specifically, the permeation amount retention rate is measured as follows. First, the separation membrane module is connected to an internal pressure type separation treatment line illustrated in FIG. 5, and N-methylpyrrolidone as a flowing liquid is continuously passed through the separation membrane module using a liquid feed circulation pump 70. In the separation membrane module, the passage S2 connected to a primary side pressure gauge 71 is used as a primary side port, and the passage S1 and the passage S2 connected to a secondary side pressure gauge 72 are used as secondary side ports. The pressure of the primary side pressure gauge 71 and the pressure of the secondary side pressure gauge 72 are adjusted by a pressure regulating valve 74 such that the arithmetic average value of the pressure of the primary side pressure gauge 71 and the pressure of the secondary side pressure gauge 72 is 1 bar. Of the liquid passing through the separation membrane module, liquid that has passed through pores of the separation membrane flows out through the passage S1 as permeate liquid separated from the flowing liquid, and the remaining liquid is recirculated in the separation treatment line through the passage S2 on the secondary side. After a lapse of 1 hour, the permeate liquid that has flowed out through the passage S1 is collected in a saucer 73, and the mass thereof is measured and taken as the mass P₀ (kg) of the permeate liquid before the treatment of filling the separation membrane module with N-methylpyrrolidone for 672 hours. Next, the separation membrane module whose mass P₀ of the permeate liquid has been measured is filled with N-methylpyrrolidone and left to stand still for 672 hours. The separation membrane module is connected to the internal pressure type separation treatment line illustrated in FIG. 5, and N-methylpyrrolidone as a flowing liquid is continuously passed through the separation membrane module using the liquid feed circulation pump 70. In the separation membrane module, the passage S2 connected to the primary side pressure gauge 71 is used as a primary side port, the passage S1 and the passage S2 connected to the secondary side pressure gauge 72 are used as secondary side ports, and the pressure of the primary side pressure gauge 71 and the pressure of the secondary side pressure gauge 72 are adjusted by the pressure regulating valve 74 such that the arithmetic average value of the pressure of the primary side pressure gauge 71 and the pressure of the secondary side pressure gauge 72 is 1 bar. Of the liquid passing through the separation membrane module, liquid that has passed through pores of the separation membrane flows out through the passage S1 as permeate liquid separated from the flowing liquid, and the remaining liquid is recirculated in the separation treatment line through the passage S2 on the secondary side. After a lapse of 1 hour, the permeate liquid that has flowed out through the passage S1 is collected in the saucer 73, and the mass thereof is measured and taken as the mass P₁ (kg) of the permeate liquid after the treatment of filling the separation membrane module with N-methylpyrrolidone for 672 hours. The permeation amount retention rate is calculated from the following equation.

$$Permeation amount retention rate ( \% ) = ( {P}_{1} / {P}_{0} ) \times 100$$

Specifically, the rejection rate retention rate is measured as follows. First, the separation membrane module is connected to the internal pressure type separation treatment line illustrated in FIG. 5, and an aqueous solution containing 0.5 mass % of dextran having a molecular weight of 60000 as a flowing liquid is continuously passed through the separation membrane module using the liquid feed circulation pump 70. In the separation membrane module, the passage S2 connected to the primary side pressure gauge 71 is used as a primary side port, and the passage S1 and the passage S2 connected to the secondary side pressure gauge 72 are used as secondary side ports. The pressure of the primary side pressure gauge 71 and the pressure of the secondary side pressure gauge 72 are adjusted by the pressure regulating valve 74 such that the arithmetic average value of the pressure of the primary side pressure gauge 71 and the pressure of the secondary side pressure gauge 72 is 1 bar. Of the liquid passing through the separation membrane module, liquid that has passed through pores of the separation membrane flows out through the passage S1 as permeate liquid separated from the flowing liquid, and the remaining liquid is recirculated in the separation treatment line through the passage S2 on the secondary side. After a lapse of 1 hour, the permeate liquid that has flowed out through the passage S1 is collected in the saucer 73, and the dextran aqueous solution concentration (C₁) of the collected liquid is measured. The rejection rate R₀ before the treatment of filling the separation membrane module with N-methylpyrrolidone for 672 hours is calculated from the dextran aqueous solution concentration (C₀, 0.5 mass %) and the concentration C₁ by the following equation.

$$Rejection rate {R}_{0} ( \% ) = ( 1 - {C}_{1} / {C}_{0} ) \times 100$$

The dextran aqueous solution concentration is measured by high-performance liquid chromatography. The measurement conditions of high-performance liquid chromatography are as follows.

### (Measurement Conditions)

Device: Aliance 2695, column heater SMH (manufactured by Waters Corporation)
Column: Ultrahydrogel 500 (manufactured by Waters Corporation)
Eluent: Ultrapure water
Temperature: 25° C.
Flow rate: 0.5 ml/min.
Detector: Differential refractometer (manufactured by Waters Corporation, 2414)

Next, the separation membrane module whose rejection rate R₀ of the permeate liquid has been measured is filled with N-methylpyrrolidone and left to stand still for 672 hours. The separation membrane module is connected to the internal pressure type separation treatment line illustrated in FIG. 5, and an aqueous solution containing 0.5 mass % of dextran having a molecular weight of 60000 as a flowing liquid is continuously passed through the separation membrane module using the liquid feed circulation pump 70. In the separation membrane module, the passage S2 connected to the primary side pressure gauge 71 is used as a primary side port, and the passage S1 and the passage S2 connected to the secondary side pressure gauge 72 are used as secondary side ports. The pressure of the primary side pressure gauge 71 and the pressure of the secondary side pressure gauge 72 are adjusted by the pressure regulating valve 74 such that the arithmetic average value of the pressure of the primary side pressure gauge 71 and the pressure of the secondary side pressure gauge 72 is 1 bar. Of the liquid passing through the separation membrane module, liquid that has passed through pores of the separation membrane flows out through the passage S1 as permeate liquid separated from the flowing liquid, and the remaining liquid is recirculated in the separation treatment line through the passage S2 on the secondary side. After a lapse of 1 hour, the permeate liquid that has flowed out through the passage S1 is collected in the saucer 73, and the dextran aqueous solution concentration (C₂) of the collected liquid is measured. The rejection rate R₁ after the treatment of filling the separation membrane module with N-methylpyrrolidone for 672 hours is calculated from the dextran aqueous solution concentration (C₀, 0.5 mass %) and the concentration C₂ by the following equation.

$$Rejection rate {R}_{1} ( \% ) = ( 1 - {C}_{2} / {C}_{0} ) \times 100$$

The rejection rate retention rate is calculated from R₀ and R₁ by the following equation.

$$Rejection rate retention rate ( \% ) = ( {R}_{1} / {R}_{0} ) \times 100$$

The permeation amount retention rate and the rejection rate retention rate can be easily achieved by performing potting using the potting agent of the present invention, selecting an appropriate material for the separation membrane and the case, curing the potting agent under curing conditions described below, or the like.

When the separation membrane constituting the separation membrane module of the present invention is a hollow fiber membrane, the blockage rate of the hollow portion of the hollow fiber membrane is not particularly limited, but is, for example, 0 to 10%. The blockage rate is preferably 0 to 5%, more preferably 0 to 2%, and still more preferably 0 to 1%, from the viewpoint of further increasing the amount of the liquid to be treated passed when the liquid to be treated is passed and the substance to be separated in the liquid to be treated is separated. In the present invention, the blockage rate is measured as follows. That is, a needle having a diameter of 75% of the inner diameter of the hollow fiber membrane and a length longer than the thickness of the cured product 5 of the potting agent in the module longitudinal direction is passed through the hollow portion (through-hole) in all the hollow fiber membranes housed in the separation membrane module from both sides in the longitudinal direction, so that the needle is passed through the through-hole. A value obtained by dividing the number of hollow fiber membranes in which the needle did not entirely fit in the through-hole (that is, there is such blockage that the needle comes into contact with the cured product 5 and the needle does not entirely fit in the through-hole in the length direction from the end portion of the hollow portion to a length point corresponding to the length of the needle) by the number of all the hollow fiber membranes ([the number of hollow fiber membranes with blockage/the number of all the hollow fiber membranes]×100) is taken as a blockage rate (%).

The separation membrane module having a low blockage rate can be manufactured, for example, by using an epoxy compound having an epoxy equivalent in the above range as the epoxy compound which is a constituent component of the potting agent.

The separation membrane module of the present invention is used for membrane-separating a liquid to be treated, and is preferably used for causing a liquid to be treated containing an organic solvent to pass through the separation membrane module to separate a substance to be separated in the liquid to be treated. The liquid to be treated may contain water together with the organic solvent. Since the separation membrane module of the present invention is excellent in resistance to a highly soluble organic solvent, the separation membrane module is more preferably used when the organic solvent contained in the liquid to be treated is a highly soluble organic solvent. In the present invention, the “highly soluble organic solvent” refers to an organic solvent containing 50 mass % or more of an aprotic polar solvent, and the content rate of the aprotic polar solvent in the organic solvent may be 60 mass % or more, 70 mass % or more, 80 mass % or more, or 90 mass % or more, or may be 100 mass %. As the content of the aprotic polar solvent in the organic solvent is higher, the separation membrane module of the present invention is more suitably used. Examples of a solvent other than the aprotic polar solvent that can be contained in the highly soluble organic solvent include a protic polar solvent and/or a non-polar solvent. Examples of the protic polar solvent include n-butanol, isopropanol, ethanol, and methanol. Examples of the non-polar solvent include hexane, benzene, toluene, chloroform, and diethyl ether.

The aprotic polar solvent is not particularly limited, and examples thereof include aprotic polar solvents having a relative permittivity of 21 or more. As for the relative permittivity of the aprotic polar solvent, a value described in “Electrochemistry and Industrial Physics, Volume 48, No. 10, 1980, page 531, The Electrochemical Society of Japan” can be referred to. Examples of the aprotic polar solvents having a relative permittivity of 21 or more include acetylacetone, acetonitrile, propionitrile, benzonitrile, dimethylformamide, dimethylacetamide, hexamethylphosphoramide, N-methylpyrrolidone, dimethylsulfoxide, sulfolane, dimethylthioformamide, N-methylthiopyrrolidone, nitromethane, nitrobenzene, propylene carbonate, ethylene carbonate, and mixed solvents containing two or more thereof.

Examples of the liquid to be treated containing a highly soluble organic solvent include a waste liquid discharged from a manufacturing process of an industrial product, a manufacturing process liquid of an industrial product, and a cleaning waste liquid of a manufacturing apparatus.

### [Method for Manufacturing Separation Membrane Module]

A method for manufacturing a separation membrane module of the present invention is not particularly limited, and a known manufacturing method can be employed except that the potting agent of the present invention is used. Specifically, the method for manufacturing a separation membrane module of the present invention includes a potting step of housing the separation membrane in the case and fixing the housed separation membrane in the case with the potting agent of the present invention. Hereinafter, a preferred example of the method for manufacturing a separation membrane module of the present invention will be described.

Examples of the potting method in the potting step include a centrifugal potting method in which a potting agent is allowed to permeate between the separation membranes by using a centrifugal force and then cured, and a static potting method in which a potting agent is allowed to permeate between the separation membranes by being fed by a metering pump or a head and allowed to naturally flow, and then cured, and from the viewpoint that the separation membrane is more easily fixed to the inner wall surface of the case in a liquid-tight or airtight manner, the centrifugal potting method is preferable.

The potting step can be performed, for example, by performing a potting treatment by a centrifugal potting method using a device 6 as illustrated in FIG. 6. The device 6 includes, in a space defined by a housing 60, a rotary driving device 61 and a rotating base 62 rotated by torque transmitted from the rotary driving device 61.

First, a plurality of separation membranes are housed in the case via the passage S2. Before the separation membranes are housed in the case, it is preferable that both end portions of the plurality of separation membranes are fixed to each other with thermocompression sealing or an adhesive, and the through-holes at both end portions of the plurality of separation membranes are sealed with an adhesive or the like. The length of the separation membrane at this time is set to such a length that both end portions thereof extend outward from the openings of the passages S2 at the both ends of the case when the separation membranes are housed in the case, and the end portions fixed with thermocompression sealing or an adhesive are preferably portions extending from the case. The case in which the separation membranes are housed is placed on the rotating base 62 such that the position of the center of gravity coincides with the central axis of rotation of the rotating base 62, and is fixed to the rotating base 62 with a fixture 63. In the case fixed to the rotating base 62, the second end portions 31 of the caps 3 at the both ends are connected to tubes 64 such that the passages S2 on both sides and the tubes 64 are in liquid-tight communication with each other. The tubes 64 communicate with the tip of a syringe 65 containing a predetermined amount of the potting agent 5 in a liquid form on the central axis of rotation of the rotating base 62. When the rotary driving device 61 is rotated, the potting agent 5 flows from the inside of the syringe 65 to the inside of the tubes 64, enters the inside of the cap 3 from the openings of the passages S2 on both sides of the case, and fills gaps between the respective separation membranes and between the separation membranes and the inner peripheral surface 33b. The rotary driving device 61 is rotated continuously at a predetermined rotational speed for a predetermined period. At the time of a centrifugal potting treatment, it is preferable to circulate hot air from a hot air dryer 66 in the housing 60 to heat the inside of the housing in advance. The centrifugal potting treatment preferably includes, for example, a first centrifugal potting treatment performed under conditions of a rotational speed of 200 to 800 rpm, an atmospheric temperature of 60 to 100° C., and a time of 10 to 30 minutes, and a second centrifugal potting treatment performed under conditions of a rotational speed of 200 to 800 rpm, an atmospheric temperature of 30 to 50° C., and a time of 3 to 6 hours. By performing the centrifugal potting treatment, the plurality of separation membranes are liquid-tightly or airtightly bonded and fixed to the inner wall surface of the case by the cured product 5 of the potting agent (see FIGS. 3 and 4).

After the potting step, the separation membrane module 1 is taken out from the device 6, the thermocompression bonding sealed portion or the adhesive portion of the plurality of separation membranes is cut off together with the cured portion of the potting agent, so that the through-hole of the separation membrane communicates with the outside at the end face of the second end portion 31 of the cap 3. Thereafter, the potted portion may be heated again and subjected to a post-curing treatment for accelerating curing. The conditions for the post-curing treatment are preferably an atmospheric temperature of 60 to 100° C. and a time of 2 to 4 hours. Thus, the separation membrane module of the present invention can be obtained.

### [Use of Composition Containing Epoxy Compound and Imidazole Compound]

As described above, in the potting step in the manufacturing of a separation membrane module, by using the composition containing the epoxy compound and the imidazole compound as a potting agent, a separation membrane module excellent in resistance to a highly soluble organic solvent can be obtained. Therefore, the composition containing the epoxy compound and the imidazole compound (that is, the composition corresponding to the above-described potting agent of the present invention) can be suitably used as a potting agent in the manufacturing of a separation membrane module.

### [Separation Method]

A separation method of the present invention is a method of causing a liquid to be treated containing an organic solvent to pass through the above-described separation membrane module of the present invention to separate a substance to be separated in the liquid to be treated.

The liquid to be treated may contain water together with the organic solvent. Since the separation membrane module of the present invention is excellent in resistance to a highly soluble organic solvent, the separation method of the present invention is preferably used when the organic solvent contained in the liquid to be treated is a highly soluble organic solvent. As described above, the “highly soluble organic solvent” refers to an organic solvent containing 50 mass % or more of an aprotic polar solvent, and the content rate of the aprotic polar solvent in the organic solvent may be 60 mass % or more, 70 mass % or more, 80 mass % or more, or 90 mass % or more, or may be 100 mass %. As the content of the aprotic polar solvent in the organic solvent is higher, the separation method of the present invention is more suitably used. The aprotic polar solvent is as described in the section of [Separation membrane module]. Examples of a solvent other than the aprotic polar solvent that can be contained in the highly soluble organic solvent include a protic polar solvent and/or a non-polar solvent. Examples of the protic polar solvent include n-butanol, isopropanol, ethanol, and methanol. Examples of the non-polar solvent include hexane, benzene, toluene, chloroform, and diethyl ether. Examples of the liquid to be treated containing a highly soluble organic solvent include a waste liquid discharged from a manufacturing process of an industrial product, a manufacturing process liquid of an industrial product, and a cleaning waste liquid of a manufacturing apparatus.

As the operating conditions in the separation method of the present invention, normal operating conditions may be appropriately adopted depending on the types of the separation membrane, the module, and the liquid to be treated.

### EXAMPLES

Hereinafter, the present invention will be specifically described with reference to Examples and Comparative Examples. However, the present invention is not limited to Examples.

### 1. Measurement Method

(1) Maximum Reaction Temperature when Potting Agent is Cured

The temperature inside the potting agent was directly measured using a thermocouple through the first centrifugal potting treatment and the second centrifugal potting treatment, and the maximum reaction temperature was recorded.

(2) Permeation Amount Retention Rate after Treatment in which Separation Membrane Module is Filled with N-Methylpyrrolidone and Left to Stand Still for 672 Hours

The separation membrane module was connected to the internal pressure type separation treatment line illustrated in FIG. 5, and N-methylpyrrolidone as a flowing liquid was continuously passed through the separation membrane module using the liquid feed circulation pump 70. In the separation membrane module, the passage S2 connected to the primary side pressure gauge 71 was used as a primary side port, and the passage S1 and the passage S2 connected to the secondary side pressure gauge 72 were used as secondary side ports. The pressure of the primary side pressure gauge 71 and the pressure of the secondary side pressure gauge 72 were adjusted by the pressure regulating valve 74 such that the arithmetic average value of the pressure of the primary side pressure gauge 71 and the pressure of the secondary side pressure gauge 72 was 1 bar. Of the liquid passing through the separation membrane module, liquid that had passed through pores of the separation membrane flowed out through the passage S1 as permeate liquid separated from the flowing liquid, and the remaining liquid was recirculated in the separation treatment line through the passage S2 on the secondary side. After a lapse of 1 hour, the permeate liquid that had flowed out through the passage S1 was collected in the saucer 73, and the mass thereof was measured and taken as the mass P₀ (kg) of the permeate liquid before the treatment of filling the separation membrane module with N-methylpyrrolidone for 672 hours. Next, the separation membrane module whose mass P₀ of the permeate liquid had been measured was filled with N-methylpyrrolidone and left to stand still for 672 hours. The separation membrane module was connected to the internal pressure type separation treatment line illustrated in FIG. 5, and N-methylpyrrolidone as a flowing liquid was continuously passed through the separation membrane module using the liquid feed circulation pump 70. In the separation membrane module, the passage S2 connected to the primary side pressure gauge 71 was used as a primary side port, the passage S1 and the passage S2 connected to the secondary side pressure gauge 72 were used as secondary side ports, and the pressure of the primary side pressure gauge 71 and the pressure of the secondary side pressure gauge 72 were adjusted by the pressure regulating valve 74 such that the arithmetic average value of the pressure of the primary side pressure gauge 71 and the pressure of the secondary side pressure gauge 72 was 1 bar. Of the liquid passing through the separation membrane module, liquid that had passed through pores of the separation membrane flowed out through the passage S1 as permeate liquid separated from the flowing liquid, and the remaining liquid was recirculated in the separation treatment line through the passage S2 on the secondary side. After a lapse of 1 hour, the permeate liquid that had flowed out through the passage S1 was collected in the saucer 73, and the mass thereof was measured and taken as the mass P₁ (kg) of the permeate liquid after the treatment of filling the separation membrane module with N-methylpyrrolidone for 672 hours. The permeation amount retention rate was calculated from the following equation.

$$Permeation amount retention rate ( \% ) = ( {P}_{1} / {P}_{0} ) \times 100$$

(3) Rejection Rate Retention Rate after Treatment in which Separation Membrane Module is Filled with N-Methylpyrrolidone and Left to Stand Still for 672 Hours

The separation membrane module was connected to the internal pressure type separation treatment line illustrated in FIG. 5, and an aqueous solution containing 0.5 mass % of dextran having a molecular weight of 60000 as a flowing liquid was continuously passed through the separation membrane module using the liquid feed circulation pump 70. In the separation membrane module, the passage S2 connected to the primary side pressure gauge 71 was used as a primary side port, and the passage S1 and the passage S2 connected to the secondary side pressure gauge 72 were used as secondary side ports. The pressure of the primary side pressure gauge 71 and the pressure of the secondary side pressure gauge 72 were adjusted by the pressure regulating valve 74 such that the arithmetic average value of the pressure of the primary side pressure gauge 71 and the pressure of the secondary side pressure gauge 72 was 1 bar. Of the liquid passing through the separation membrane module, liquid that had passed through pores of the separation membrane flowed out through the passage S1 as permeate liquid separated from the flowing liquid, and the remaining liquid was recirculated in the separation treatment line through the passage S2 on the secondary side. After a lapse of 1 hour, the permeate liquid that had flowed out through the passage S1 was collected in the saucer 73, and the dextran aqueous solution concentration (C₁) of the collected liquid was measured. The rejection rate R₀ before the treatment of filling the separation membrane module with N-methylpyrrolidone for 672 hours was calculated from the dextran aqueous solution concentration (C₀, 0.5 mass %) and the concentration C₁ by the following equation.

$$Rejection rate {R}_{0} ( \% ) = ( 1 - {C}_{1} / {C}_{0} ) \times 100$$

The dextran aqueous solution concentration was measured by high-performance liquid chromatography. The measurement conditions of high-performance liquid chromatography are as follows.

### (Measurement Conditions)

Device: Aliance 2695, column heater SMH (manufactured by Waters Corporation)
Column: Ultrahydrogel 500 (manufactured by Waters Corporation)
Eluent: Ultrapure water
Temperature: 25° C.
Flow rate: 0.5 ml/min.
Detector: Differential refractometer (manufactured by Waters Corporation, 2414)

Next, the separation membrane module whose rejection rate R₀ of the permeate liquid had been measured was filled with N-methylpyrrolidone and left to stand still for 672 hours. The separation membrane module was connected to the internal pressure type separation treatment line illustrated in FIG. 5, and an aqueous solution containing 0.5 mass % of dextran having a molecular weight of 60000 as a flowing liquid was continuously passed through the separation membrane module using the liquid feed circulation pump 70. In the separation membrane module, the passage S2 connected to the primary side pressure gauge 71 was used as a primary side port, and the passage S1 and the passage S2 connected to the secondary side pressure gauge 72 were used as secondary side ports. The pressure of the primary side pressure gauge 71 and the pressure of the secondary side pressure gauge 72 were adjusted by the pressure regulating valve 74 such that the arithmetic average value of the pressure of the primary side pressure gauge 71 and the pressure of the secondary side pressure gauge 72 was 1 bar. Of the liquid passing through the separation membrane module, liquid that had passed through pores of the separation membrane flowed out through the passage S1 as permeate liquid separated from the flowing liquid, and the remaining liquid was recirculated in the separation treatment line through the passage S2 on the secondary side. After a lapse of 1 hour, the permeate liquid that had flowed out through the passage S1 was collected in the saucer 73, and the dextran aqueous solution concentration (C₂) of the collected liquid was measured. The rejection rate R₁ after the treatment of filling the separation membrane module with N-methylpyrrolidone for 672 hours was calculated from the dextran aqueous solution concentration (C₀, 0.5 mass %) and the concentration C₂ by the following equation.

$$Rejection rate {R}_{1} ( \% ) = ( 1 - {C}_{2} / {C}_{0} ) \times 100$$

The rejection rate retention rate was calculated from R₀ and R₁ by the following equation.

$$Rejection rate retention rate ( \% ) = ( {R}_{1} / {R}_{0} ) \times 100$$

### (4) Epoxy Equivalent of Epoxy Compound

The epoxy equivalent of the epoxy compound was measured according to a potentiometric titration method defined in JIS K 7236:2001 (Determination of epoxy equivalent in epoxy resins) by dissolving a precisely weighed sample in chloroform, adding acetic acid and a tetraethylammonium bromide-acetic acid solution, and then performing potentiometric titration with 0.1 mol/L perchloric acid-acetic acid standard solution.

### (5) Viscosity Before Curing of Potting Agent

The viscosity before curing of the potting agent for a separation membrane module was measured according to a viscosity measurement method using a co-axial double cylindrical rotary viscometer specified in 8 of JIS Z 8803:2011 after raw materials such as an epoxy compound and an imidazole compound constituting the potting agent were mixed and degassed for 30 seconds using a vacuum pump. Specifically, an outer cylinder having an inner diameter of 12 mm and a depth of 47 mm, and a rotor number “ST(17)” (high viscosity type) having an outer diameter of 7.6 mm were used, 2.5 ml of the potting agent before being cured was placed in the outer cylinder, a spindle was inserted therein, the temperature was kept constant in a water bath set at 40° C., and then the viscosity was measured using a B-type viscometer “TVB-15” (inner cylinder constant speed type) manufactured by Toki Sangyo Co., Ltd. by appropriately adjusting the number of revolutions to the number of revolutions at which the measurement was possible. The measurement was performed at 60 rpm in Example 1 and 0.6 rpm in Example 9.

### (6) Blockage Rate of Hollow Portion of Hollow Fiber Membrane

A needle having a diameter of 75% of the inner diameter of the hollow fiber membrane and a length longer than the thickness of the cured product of the potting agent in the module longitudinal direction was passed through the hollow portion (through-hole) in all the hollow fiber membranes housed in the separation membrane module from both sides in the longitudinal direction, so that the needle was passed through the through-hole. The blockage rate (%) was calculated by the following equation from the number of hollow fiber membranes in which the needle did not entirely fit in the through-hole (that is, there is such blockage that the needle comes into contact with the cured product of the potting agent and the needle does not entirely fit in the through-hole in the length direction from the end portion of the hollow portion to a length point corresponding to the length of the needle) and the number of all the hollow fiber membranes.

$$Blockage rate ( \% ) = ( Number of hollow fiber membranes with blockage / Number of all hollow fiber membranes ) \times 100$$

### (7) Outer Diameter and Inner Diameter of Hollow Fiber Membrane

The outer diameter and the inner diameter of each of the hollow fiber membranes were determined by observing five hollow fiber membranes at a magnification of 200 times with an optical microscope, measuring the outer diameter and the inner diameter of each of the hollow fiber membranes (locations where the diameters were maximum), and calculating the average values of the outer diameter and the inner diameter.

### 2. Raw Materials of Potting Agent for Separation Membrane Module

Raw materials used in Examples and Comparative Examples are shown below.

### (1) (A) Epoxy Compound

(A-1) Diglycidyl ether type epoxy compound (trade name: jER (registered trademark) 828 manufactured by Mitsubishi Chemical Corporation, bisphenol A diglycidyl ether, epoxy equivalent: 186 (g/eq))
(A-1-2) Diglycidyl ether type epoxy compound (trade name: jER (registered trademark) 834 manufactured by Mitsubishi Chemical Corporation, bisphenol A diglycidyl ether, epoxy equivalent: 245 (g/eq))
(A-2) Novolac type epoxy resin (trade name: jER (registered trademark) 154 manufactured by Mitsubishi Chemical Corporation, phenol novolac type epoxy resin)
(A-3) Glycidyl amine type epoxy compound (trade name: jER (registered trademark) 604 manufactured by Mitsubishi Chemical Corporation, N,N,N,N-tetraglycidyldiaminodiphenylmethane)
(A-4) Epoxy resin having a triazine skeleton (trade name: TEPIC (registered trademark) VL manufactured by Nissan Chemical Corporation, tris(4,5-epoxypentyl) isocyanurate)

### (2) (B) Imidazole Compound

(B-1) 2-Ethyl-4-methylimidazole (trade name: CUREZOL (registered trademark) 2E4MZ manufactured by SHIKOKU CHEMICALS CORPORATION)
(B-2) 2-Methylimidazole (trade name: CUREZOL (registered trademark) 2 MZ-H manufactured by SHIKOKU CHEMICALS CORPORATION)
(B-3) 2-Undecylimidazole (trade name: CUREZOL (registered trademark) C₁₁Z manufactured by SHIKOKU CHEMICALS CORPORATION)
   (3) (C) Components Other than Epoxy Compound and Imidazole Compound
(C-1) Boron trifluoride monoethylamine (manufactured by STELLA CHEMIFA CORPORATION, boron trifluoride-amine complex)
(C-2) N,N-Dimethyl-n-hexylamine (manufactured by FUJIFILM Wako Pure Chemical Corporation, tertiary amine compound)

### 3. Production Example

### Example 1

First, a hollow fiber membrane serving as a separation membrane was prepared. Specifically, 230 g of a polyamide 6 chip (A1030BRT manufactured by UNITIKA LTD., relative viscosity: 3.53), 205 g of sulfolane (manufactured by SUMITOMO SEIKA CHEMICALS CO., LTD.), and 565 g of dimethylsulfone (manufactured by Tokyo Chemical Industry Co., Ltd.) were stirred at 180° C. for 1.5 hours to be dissolved, and the stirring speed was reduced to defoam for 1 hour, thereby preparing a membrane-forming stock solution. The membrane-forming stock solution was fed to a spinneret (double-tube nozzle for hollow fiber production having a double tube structure) via a metering pump and extruded at 10.0 g/min. A spinneret having a pore size with an outer diameter of 1.5 mm and an inner diameter of 0.6 mm was used. To the internal liquid, glycerin: polyethylene glycol 400=2:8 was fed at a liquid feeding rate of 4.0 g/min. The extruded membrane-forming stock solution was charged into a coagulation bath composed of a 50 mass % propylene glycol aqueous solution at 5° C. through an air gap of 10 mm, cooled and solidified, and taken up at a take-up rate of 20 m/min. The obtained hollow fiber was immersed in water for 24 hours to extract the solvent, and then dried in a hot air dryer at 50° C. for 1 hour to obtain a hollow fiber membrane composed of polyamide 6. The obtained hollow fiber membrane composed of polyamide 6 (PA6) had an outer diameter of 500 μm and an inner diameter of 300 μm. The hollow fiber membrane composed of polyamide 6 was cut into a length of 320 mm, 200 hollow fiber membranes were bundled, and both ends were fusion-sealed using a thermal sealer and subjected to a thermocompression bonding sealing treatment.

Next, as raw materials of the potting agent for a separation membrane module, the (A-1) diglycidyl ether type epoxy compound as an epoxy compound and the (B-1) 2-ethyl-4-methylimidazole as an imidazole compound were mixed and stirred so as to have the composition in Table 1, thereby obtaining a potting agent for a separation membrane module of Example 1.

The configurations of the casing and the cap were common to Examples 1 to 9 and Comparative Examples 1 and 2. The casing had an inner diameter of 17 mm, an outer diameter of 20 mm, and a length of 270 mm. The inner diameter of the first end portion of the cap was 20 mm, and the length in the axial direction of the inner peripheral surface of the first end portion was 15 mm. The casing and the cap were both molded from polyamide 6 (A1030BRT manufactured by UNITIKA LTD., relative viscosity: 3.53).

In Example 1, the potting agent for a separation membrane module was also used as an adhesive for bonding and fixing a casing and a cap. That is, the (A-1) diglycidyl ether type epoxy compound as an epoxy compound and the (B-1) 2-ethyl-4-methylimidazole as an imidazole compound were mixed and stirred to form an adhesive so as to have the composition in Table 1, and the casing and the cap were bonded and fixed with the adhesive to form a case. The above-described thermocompression-bonded hollow fiber membrane bundle was housed in the case.

The case housing the hollow fiber membrane bundle was set in a centrifugal potting device as illustrated in FIG. 6, and using the potting agent for a separation membrane module of Example 1, the first centrifugal potting treatment was performed under conditions of a rotational speed of 400 rpm, an atmospheric temperature of 80° C., and a time of 20 minutes, and then the second centrifugal potting treatment was performed under conditions of a rotational speed of 400 rpm, an atmospheric temperature of 40° C., and a time of 4.5 hours. Thereafter, the case was taken out from the centrifugal potting device, the potted portion of the hollow fiber membrane bundle extending from both ends of the case was cut off, and the through-hole of the hollow fiber membrane bundle was communicated with the outside. Thereafter, the case was subjected to a post-curing treatment of heat-treating the case at 80° C. for 3 hours in a hot air dryer to obtain a separation membrane module of Example 1 as illustrated in FIGS. 1 to 4.

### Example 2

A separation membrane module of Example 2 was obtained in the same manner as in Example 1, except that as raw materials of the potting agent for a separation membrane module and the adhesive for bonding and fixing a casing and a cap, the (A-3) glycidyl amine type epoxy compound as an epoxy compound and the (B-1) 2-ethyl-4-methylimidazole as an imidazole compound were mixed and stirred so as to have the composition in Table 1, thereby forming a potting agent for a separation membrane module and an adhesive for bonding and fixing a casing and a cap of Example 2.

### Example 3

A separation membrane module of Example 3 was obtained in the same manner as in Example 1, except that as raw materials of the potting agent for a separation membrane module and the adhesive for bonding and fixing a casing and a cap, the (A-4) epoxy resin having a triazine skeleton as an epoxy compound and the (B-1) 2-ethyl-4-methylimidazole as an imidazole compound were mixed and stirred so as to have the composition in Table 1, thereby forming a potting agent for a separation membrane module and an adhesive for bonding and fixing a casing and a cap of Example 3.

### Example 4

A separation membrane module of Example 4 was obtained in the same manner as in Example 1, except that as raw materials of the potting agent for a separation membrane module and the adhesive for bonding and fixing a casing and a cap, the (A-4) epoxy resin having a triazine skeleton as an epoxy compound and the (B-2) 2-methylimidazole as an imidazole compound were mixed and stirred so as to have the composition in Table 1, thereby forming a potting agent for a separation membrane module and an adhesive for bonding and fixing a casing and a cap of Example 4.

### Example 5

A separation membrane module of Example 5 was obtained in the same manner as in Example 1, except that as raw materials of the potting agent for a separation membrane module and the adhesive for bonding and fixing a casing and a cap, the (A-4) epoxy resin having a triazine skeleton as an epoxy compound and the (B-3) 2-undecylimidazole as an imidazole compound were mixed and stirred so as to have the composition in Table 1, thereby forming a potting agent for a separation membrane module and an adhesive for bonding and fixing a casing and a cap of Example 5.

### Example 6

First, a hollow fiber membrane serving as a separation membrane was prepared. Specifically, 230 g of a polyamide 12 chip (RILSAN AECN0TL manufactured by Arkema, relative viscosity: 2.25), 205 g of sulfolane (manufactured by SUMITOMO SEIKA CHEMICALS CO., LTD.), and 565 g of dimethylsulfone (manufactured by Tokyo Chemical Industry Co., Ltd.) were stirred at 180° C. for 1.5 hours to be dissolved, and the stirring speed was reduced to defoam for 1 hour, thereby preparing a membrane-forming stock solution. The membrane-forming stock solution was fed to a spinneret (double-tube nozzle for hollow fiber production having a double tube structure) via a metering pump and extruded at 10.0 g/min. A spinneret having a pore size with an outer diameter of 1.5 mm and an inner diameter of 0.6 mm was used. To the internal liquid, glycerin:polyethylene glycol 400=2:8 was fed at a liquid feeding rate of 4.0 g/min. The extruded membrane-forming stock solution was charged into a coagulation bath composed of a 50 mass % propylene glycol aqueous solution at 5° C. through an air gap of 10 mm, cooled and solidified, and taken up at a take-up rate of 20 m/min. The obtained hollow fiber was immersed in water for 24 hours to extract the solvent, and then dried in a hot air dryer at 50° C. for 1 hour to obtain a hollow fiber membrane composed of polyamide 12. The obtained hollow fiber membrane composed of polyamide 12 (PA12) had an outer diameter of 460 μm and an inner diameter of 290 μm. The hollow fiber membrane composed of polyamide 12 was cut into a length of 320 mm, 200 hollow fiber membranes were bundled, and both ends were fusion-sealed using a thermal sealer and subjected to a thermocompression bonding sealing treatment.

A separation membrane module of Example 6 was obtained in the same manner as in Example 3, except that the hollow fiber membrane was changed to the hollow fiber membrane composed of polyamide 12.

### Example 7

A separation membrane module of Example 7 was obtained in the same manner as in Example 1, except that as raw materials of the potting agent for a separation membrane module and the adhesive for bonding and fixing a casing and a cap, the (A-2) novolac type epoxy resin as an epoxy compound and the (B-1) 2-ethyl-4-methylimidazole as an imidazole compound were mixed and stirred so as to have the composition in Table 1, thereby forming a potting agent for a separation membrane module and an adhesive for bonding and fixing a casing and a cap of Example 7.

### Example 8

A separation membrane module of Example 8 was obtained in the same manner as in Example 1, except that as raw materials of the potting agent for a separation membrane module and the adhesive for bonding and fixing a casing and a cap, the (A-2) novolac type epoxy resin as an epoxy compound and the (B-1) 2-ethyl-4-methylimidazole as an imidazole compound were mixed and stirred so as to have the composition in Table 1, thereby forming a potting agent for a separation membrane module and an adhesive for bonding and fixing a casing and a cap of Example 8.

### Example 9

A separation membrane module of Example 9 was obtained in the same manner as in Example 1, except that as raw materials of the potting agent for a separation membrane module and the adhesive for bonding and fixing a casing and a cap, the (A-1-2) diglycidyl ether type epoxy compound as an epoxy compound and the (B-1) 2-ethyl-4-methylimidazole as an imidazole compound were mixed and stirred so as to have the composition in Table 1, thereby forming a potting agent for a separation membrane module and an adhesive for bonding and fixing a casing and a cap of Example 9.

### Comparative Example 1

A separation membrane module of Comparative Example 1 was obtained in the same manner as in Example 1, except that as raw materials of the potting agent for a separation membrane module and the adhesive for bonding and fixing a casing and a cap, the (A-1) diglycidyl ether type epoxy compound as an epoxy compound and the (C-1) boron trifluoride monoethylamine as a component other than the imidazole compound were mixed and stirred so as to have the composition in Table 1, thereby forming a potting agent for a separation membrane module and an adhesive for bonding and fixing a casing and a cap of Comparative Example 1.

### Comparative Example 2

A separation membrane module of Comparative Example 2 was obtained in the same manner as in Example 1, except that as raw materials of the potting agent for a separation membrane module and the adhesive for bonding and fixing a casing and a cap, the (A-1) diglycidyl ether type epoxy compound as an epoxy compound and the (C-2) N,N-dimethyl-n-hexylamine as a component other than the imidazole compound were mixed and stirred so as to have the composition in Table 1, thereby forming a potting agent for a separation membrane module and an adhesive for bonding and fixing a casing and a cap of Comparative Example 2.

The results are shown in Table 1.

TABLE 1

| | | | | Example | Example | Example | Example | Example | Example | Example | Example | Example | Comparative | Comparative |
|---|---|---|---|---|---|---|---|---|---|---|---|---|---|---|
| | | | | 1 | 2 | 3 | 4 | 5 | 6 | 7 | 8 | 9 | Example 1 | Example 2 |
| Constituent material of separation membrane | | | | PA6 | PA6 | PA6 | PA6 | PA6 | PA12 | PA6 | PA6 | PA6 | PA6 | PA6 |
| Compositions of | (A) Epoxy | Diglycidyl ether type | A-1 | 100 | 0 | 0 | 0 | 0 | 0 | 0 | 0 | 0 | 100 | 100 |
| potting agent | compound | epoxy compound | | | | | | | | | | | | |
| for separation | (parts by | Diglycidyl ether type | (A-1-2) | 0 | 0 | 0 | 0 | 0 | 0 | 0 | 0 | 100 | 0 | 0 |
| membrane module | mass) | epoxy compound | | | | | | | | | | | | |
| and adhesive | | Novolac type epoxy resin | A-2 | 0 | 0 | 0 | 0 | 0 | 0 | 100 | 100 | 0 | 0 | 0 |
| for bonding | | Glycidyl amine type epoxy | A-3 | 0 | 100 | 0 | 0 | 0 | 0 | 0 | 0 | 0 | 0 | 0 |
| and fixing | | compound | | | | | | | | | | | | |
| cap and casing | | Epoxy resin having triazine | A-4 | 0 | 0 | 100 | 100 | 100 | 100 | 0 | 0 | 0 | 0 | 0 |
| | | skeleton | | | | | | | | | | | | |
| | (B) | 2-Ethyl-4-methylimidazole | B-1 | 3.5 | 5.0 | 3.5 | 0 | 0 | 3.5 | 1.0 | 3.5 | 1.7 | 0 | 0 |
| | Imidazole | 2-Methylimidazole | B-2 | 0 | 0 | 0 | 3.5 | 0 | 0 | 0 | 0 | 0 | 0 | 0 |
| | compound | 2-Undecylimidazole | B-3 | 0 | 0 | 0 | 0 | 7.0 | 0 | 0 | 0 | 0 | 0 | 0 |
| | (parts by | | | | | | | | | | | | | |
| | mass) | | | | | | | | | | | | | |
| | (C) Other | Boron trifluoride-amine | C-1 | 0 | 0 | 0 | 0 | 0 | 0 | 0 | 0 | 0 | 3.5 | 0 |
| | components | complex | | | | | | | | | | | | |
| | (parts by | Tertiary amine compound | C-2 | 0 | 0 | 0 | 0 | 0 | 0 | 0 | 0 | 0 | 0 | 3.5 |
| | mass) | | | | | | | | | | | | | |

| | | | | | | | | | | | |
|---|---|---|---|---|---|---|---|---|---|---|---|
| Total (parts by mass) | 103.5 | 105 | 103.5 | 103.5 | 107 | 103.5 | 101 | 103.5 | 101.7 | 103.5 | 103.5 |

| (A) Epoxy equivalent of epoxy compound | | g/eq | 186 | — | — | — | — | — | — | — | 245 | — | — |
|---|---|---|---|---|---|---|---|---|---|---|---|---|---|
| Viscosity before curing of potting agent | | P | 15 | — | — | — | — | — | — | — | 622 | — | — |
| Rejection rate | | % | 1.5 | — | — | — | — | — | — | — | 0 | — | — |
| Maximum reaction temperature when potting agent is cured | | ° C. | 136 | 204 | 143 | 132 | 159 | 145 | 195 | 211 | 115 | 200 | 206 |
| N-Methylpyrrolidone | Permeation amount retention | % | 105 | 104 | 105 | 103 | 101 | 105 | 115 | 111 | 104 | 120 | >200 |
| Retention rate after | rate | | | | | | | | | | | | |
| 672 h immersion | Rejection rate retention rate | % | 99 | 85 | 98 | 89 | 86 | 99 | 82 | 89 | 97 | 70 | 15 |

The separation membrane modules of Examples 1 to 9 were excellent in resistance to N-methylpyrrolidone since potting was performed using the potting agent containing an epoxy compound and an imidazole compound.

Among them, the separation membrane modules of Examples 1 to 6, 8, and 9 were more excellent in resistance to N-methylpyrrolidone since potting was performed using the potting agent containing 1.7 to 7.0 parts by mass of an imidazole compound per 100 parts by mass of an epoxy compound.

Particularly, the separation membrane modules of Examples 1, 3, 6, and 9 were further more excellent to N-methylpyrrolidone since potting was performed using the potting agent containing a diglycidyl ether type epoxy compound or an epoxy resin having a triazine skeleton as an epoxy compound and 2-ethyl-4-methylimidazole as an imidazole compound.

When the blockage rate in Example 1 is compared with that in Example 9, the blockage rate in Example 1 is 1.5%, and the blockage rate in Example 9 is 0%. Therefore, it can be said that the potting agent containing an epoxy compound having an epoxy equivalent of 245 g/eq used in Example 9 makes it easier to prevent the blockage of the hollow portion (through-hole) of the hollow fiber membrane as compared with the potting agent containing an epoxy compound having an epoxy equivalent of 186 g/eq used in Example 1.

On the other hand, since potting was performed using the potting agent not containing an imidazole compound, the separation membrane modules of Comparative Examples 1 and 2 were inferior in resistance to N-methylpyrrolidone, liquid leakage from the separation membrane module occurred, the permeation amount increased, and the rejection rate decreased.

### DESCRIPTION OF REFERENCE SIGNS

1: Separation membrane module
2: Casing
3: Cap
4: Separation membrane
5: Cured product of potting agent

1. A potting agent for a separation membrane module, comprising an epoxy compound and an imidazole compound.

2. The potting agent for a separation membrane module according to claim 1, wherein a content of the imidazole compound is 0.2 to 12 parts by mass per 100 parts by mass of the epoxy compound.

3. The potting agent for a separation membrane module according to claim 1, wherein the epoxy compound contains one or more selected from the group consisting of a diglycidyl ether type epoxy resin and an epoxy resin having a triazine skeleton.

4. The potting agent for a separation membrane module according to claim 1, wherein the imidazole compound is 2-ethyl-4-methylimidazole.

5. A separation membrane module potted with the potting agent for a separation membrane module according to claim 1.

6. The separation membrane module according to claim 5, wherein the separation membrane is a membrane containing polyamide.

7. The separation membrane module according to claim 5, wherein the separation membrane module is used for causing a liquid to be treated containing an organic solvent to pass through the separation membrane module to separate a substance to be separated in the liquid to be treated.

8. The separation membrane module according to claim 7, wherein the organic solvent is an aprotic polar solvent.

9. The separation membrane module according to claim 5, wherein both of a permeation amount retention rate and a rejection rate retention rate after a treatment in which the separation membrane module is filled with N-methylpyrrolidone and left to stand still for 672 hours are 80% or more.

10. A separation method comprising causing a liquid to be treated containing an organic solvent to pass through the separation membrane module according to claim 5 to separate a substance to be separated in the liquid to be treated.

11. Use of a composition containing an epoxy compound and an imidazole compound as a potting agent in manufacturing of a separation membrane module.

12. A method for manufacturing a separation membrane module including a case and a separation membrane housed in the case, the method comprising:
a potting step of housing the separation membrane in the case and fixing the housed separation membrane in the case with the potting agent for a separation membrane module according to claim 1.

13. The potting agent for a separation membrane module according to claim 2, wherein the epoxy compound contains one or more selected from the group consisting of a diglycidyl ether type epoxy resin and an epoxy resin having a triazine skeleton.

14. The potting agent for a separation membrane module according to claim 2, wherein the imidazole compound is 2-ethyl-4-methylimidazole.

15. A separation membrane module potted with the potting agent for a separation membrane module according to claim 2.

16. The separation membrane module according to claim 15, wherein the separation membrane is a membrane containing polyamide.

17. The separation membrane module according to claim 15, wherein the separation membrane module is used for causing a liquid to be treated containing an organic solvent to pass through the separation membrane module to separate a substance to be separated in the liquid to be treated.

18. The separation membrane module according to claim 17, wherein the organic solvent is an aprotic polar solvent.

19. The separation membrane module according to claim 15, wherein both of a permeation amount retention rate and a rejection rate retention rate after a treatment in which the separation membrane module is filled with N-methylpyrrolidone and left to stand still for 672 hours are 80% or more.

20. A separation method comprising causing a liquid to be treated containing an organic solvent to pass through the separation membrane module according to claim 15 to separate a substance to be separated in the liquid to be treated.
